(19) United States
(12) Patent Application Publication
(10) Pub. No.: US 2024/0119384 A1
(43) Pub. Date: Apr. 11, 2024

(54) User Experience by Detecting Unusual User Call Frequency

(71) Applicant: Goldman Sachs & Co. LLC, New York, NY (US)

(72) Inventors: Saurabh Kumar, Irving, TX (US); Arushi Jain, Noida (IN); Debangshu Roy, Bengaluru (IN)

(21) Appl. No.: 17/963,673

(22) Filed: Oct. 11, 2022

(51) Int. Cl. G06Q 10/06; G06Q 30/00

(52) U.S. Cl. CPC G06Q 10/0633; G06Q 30/016

(57) ABSTRACT

A system according to various embodiments manages user interactions with a helpdesk. The system determines a user satisfaction quota for a user based on an aggregate frequency with which the user called the helpdesk. The helpdesk receives a new call from the user. The new call is answered by an agent of the helpdesk. The system determines a recent interaction score and compares the recent interaction score with the user satisfaction quota for the user. If the system determines based on the comparison, whether the user is a dissatisfied user. If the user is marked as a dissatisfied user, the system generates a summary of a context identifying factors likely to contribute to dissatisfaction of the user and sends the summary of the context for presentation the agent of the helpdesk.

### BACKGROUND

### Field of Art

This disclosure relates in general to information processing systems, and in particular to improving a helpdesk system based on detection of unusual user call frequency.

### Description of the Related Art

Online systems manage user interactions performed by users with the online system. For example, a helpdesk system may receive requests from users and connect them with agents for processing their requests. A user may interact using various communication mechanisms, for example, via calls, messaging, chat, and so on. If a user's issue is not resolved after an interaction, the user may contact the helpdesk system again. A user that contacts the helpdesk repeatedly for the same issue or for multiple issues typically has poor user experience. For example, the user may have to provide the same information to the helpdesk agent during every subsequent interaction resulting in longer sessions. This results in poor user experience and also wastes resources including resources of helpdesk agents as well as computing resources of the helpdesk system.

### SUMMARY

A system according to various embodiments manages user interactions with a helpdesk. The helpdesk is associated with an online system and one or more agents that answer calls received from users. The system monitors user requests received by the helpdesk from users. The system determines a user satisfaction quota for a user based on an aggregate frequency with which the user called the helpdesk. The helpdesk receives a new call from the user. The new call is answered by an agent of the helpdesk. The system determines a recent interaction score based on factors comprising a frequency with which the user called the helpdesk in a time interval. The system compares recent interaction score with the user satisfaction quota for the user. If the system determines based on the comparison, that the recent interaction score exceeds the user satisfaction quota for the user, the system marks the user as a dissatisfied user. If the user is marked as a dissatisfied user, the system generates a summary of a context identifying factors likely to contribute to dissatisfaction of the user and sends the summary of the context for presentation the agent of the helpdesk.

### BRIEF DESCRIPTION OF DRAWINGS

FIG. 1 is a block diagram of a system environment for handling user interactions with the helpdesk, according to one embodiment.

FIG. 2 is a block diagram illustrating components of the user interaction engine of the online system, according to one embodiment.

FIGS. 3A-B illustrates monitoring of user interactions with helpdesk according to an embodiment.

FIG. 4 is a flow chart illustrating the process for collecting the information relevant for a user request to helpdesk according to an embodiment.

FIG. 5 illustrates the generation of a summary describing the context of the user interaction according to an embodiment.

FIG. 6 is a block diagram illustrating a functional view of a typical computer system according to one embodiment.

The figures depict various embodiments for purposes of illustration only. One skilled in the art will readily recognize from the following discussion that alternative embodiments of the structures and methods illustrated herein may be employed without departing from the principles of the embodiments described herein.

The figures use like reference numerals to identify like elements. A letter after a reference numeral, such as “115A,” indicates that the text refers specifically to the element having that particular reference numeral. A reference numeral in the text without a following letter, such as “115,” refers to any or all of the elements in the figures bearing that reference numeral.

### DETAILED DESCRIPTION

An online system provides support for a helpdesk. Users may contact the helpdesk via phone calls, via online chat, messaging, or any other communication channel. If a user issue is not resolved during the first user interaction, the user may have to call again at a later point in time. During the subsequent calls, the user experience may be especially poor since the helpdesk agent that answers the user call typically does not have any context for the current call and has to ask the user for all the information. The user is required to repeat a lot of information provided in previous calls to provide the context.

The online system according to various embodiments performs a machine learning based analysis of past user interactions to automatically determine whether the user is unhappy due to a poor user experience while interacting with the helpdesk. The system further generates a context for the user's current call and providing to the helpdesk agent along with explanation of various issues that the user may be calling for. This allows the helpdesk agent to have an informed interaction with the user, thereby improving the user experience and also improving the efficiency of usage of computing resources and user resources used for the particular user interaction as well as possible subsequent interactions by helping resolve the user issues sooner. For example, the system extracts the necessary information relevant to the user interaction, thereby reducing a number of accesses that an agent may perform with the online system to access the information, reducing the length of a session represented by the user call that corresponds to a session between the agent and the online system, reducing the network bandwidth due to fewer interactions and reduced amount of information being provided to the client device of the agent by the online system, and so on.

System Environment

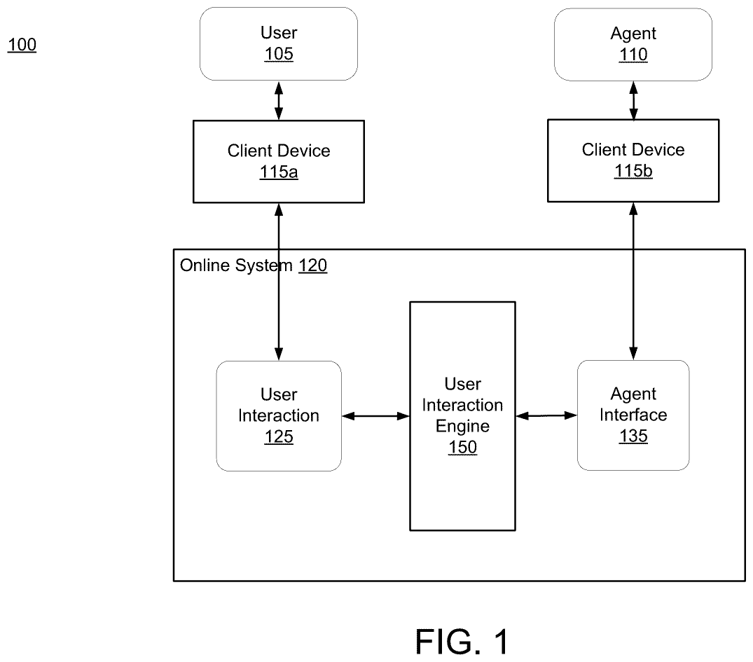

FIG. 1 is a block diagram of a system environment 100 for handling user interactions with the helpdesk, according to one embodiment. The system environment 100 includes an online system 120 and one or more client devices 115. The online system 120 includes a user interaction engine 150. The online system 120 may include other components not shown in FIG. 1, for example, scheduler, load balancer, various applications, other types of data stores, and so on. The system environment 100 may include other elements not shown in FIG. 1, for example, a network.

A user performs user interactions with the helpdesk via a communication channel, for example, a phone, an online chat, and so on. Although FIG. 1 shows the user interaction 125 being performed by the user 105 using a client device 115A, the user may perform the user interaction without directly interacting with the online system, for example, by making a call via a phone independent of the online system. In this situation, the information describing the user interaction 125 may be provided to the online system 120 separately, for example, by an agent 110 or the helpdesk. An agent of the helpdesk receives a user request, for example, a call and interacts with the user to resolve the issue that the user may be calling about. A helpdesk comprises one or more agents (or operators) and the online system 120 used by the agents. The agents receive user requests, for example, user calls and perform actions related to the user requests. The agents interact with the online system 120 via a client device 115B to access information associated with the user, for example, to get additional information associated with the user including any previous user interactions with the helpdesk. Agents 110 of the helpdesk may interact with the online system, 120 to provide information describing the current user call, for example, any notes related to the user interaction. In some embodiments, the user interaction may be stored as a transcript of the user session, for example, a transcript of the user call or an online chat session performed with the user. For example, the system may store voice recording of the conversation of the calls; call statistics (number of dropped calls, audio/network connection quality, call duration, and so on; email threads representing full conversations, and so on.

The online system 120 includes a user interaction engine 150 that analyzes user information to determine whether the user 105 should be flagged as a dissatisfied user who needs additional attention compared to a user with a normal user interaction. If the user interaction engine 150 flags the user as a dissatisfied user, the user interaction engine 150 collects additional information describing the user and provides the information to the agent 110 via the agent interface 135. The additional information allows the agent to handle the dissatisfied user in a manner that provides improved user experience. Although all user information is accessible via the online system 120, the information may be stored in various places and difficult to assimilate and process in time for a call, particularly since the call has to be handled in real time. The user interaction engine 150 extracts the appropriate information that is necessary for addressing the current user request while taking into consideration previous user interactions that may be relevant for determining causes of the user's dissatisfaction. The user interaction engine 150 further ranks the information and collects the information for presenting via the agent interface 135.

The online system 120 and client devices 115 shown in FIG. 1 represent computing devices. A computing device can be a conventional computer system executing, for example, a Microsoft™ Windows™-compatible operating system (OS), Apple™ OS X, and/or a Linux OS. A computing device can also be a device such as a personal digital assistant (PDA), mobile telephone, video game system, etc.

The client devices 115 may interact with the online system 120 via a network (not shown in FIG. 1). The network uses a networking protocol such as the transmission control protocol/Internet protocol (TCP/IP), the user datagram protocol (UDP), internet control message protocol (ICMP), etc. The data exchanged over the network can be represented using technologies and/or formats including the hypertext markup language (HTML), the extensible markup language (XML), etc.

System Architecture

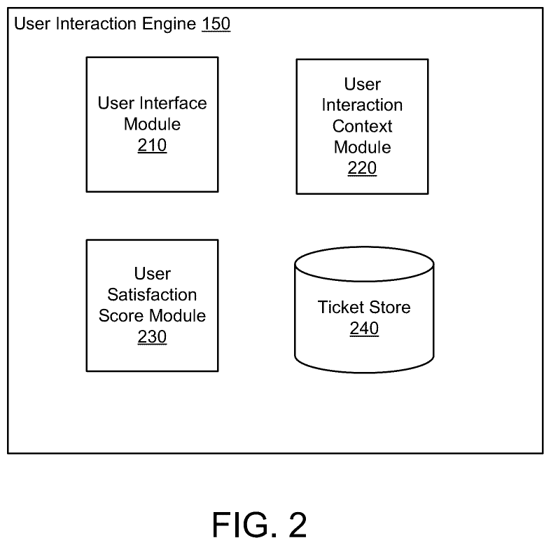

FIG. 2 is a block diagram illustrating components of the user interaction engine of the online system, according to one embodiment. The online system 120 comprises a user interface module 210, a user interaction context module 220, a recent interaction score module, and a ticket store. Other embodiments can have different and/or other components than the ones described here, and that the functionalities can be distributed among the components in a different manner.

The ticket store 240 stores records describing issues reported by the user. A user request to the helpdesk is typically regarding an issue faced by the user. The issue faced by the user may be stored as a record in a data store of the online system. The record describing the issue may be referred to as a ticket. A ticket has an identifier, information identifying the user, information describing the issue faced by the user, and information describing user interactions associated with the issue. An issue may have an issue type representing a category of issues, for example, whether the issue concerns usability of a particular product, whether the issue concerns a crash in a program, whether the issue concerns downtime of a certain service, whether the issue concerns performance of a certain issue. The various categories or types of issues may be specified by an expert and stored as metadata. Alternately, the various categories or types of issues may be determined by the online system by analyzing a set of previously encountered issues by using a categorization technique, for example, by clustering the issues into multiple clusters and assigning a category of issues to each cluster. An issue may identify a product or service associated with the issue, for example, if the user ran into a problem while using a particular product or service, that product and service is identified in the issue. According to an embodiment, issue is associated with a measure of severity of the issue indicating a measure of user dissatisfaction that the issue is likely to cause. For example, a simple usability issue of a product or website may be considered less severe compared to a popular service being down or a defect in a significant feature of a product. According to an embodiment, issue is associated with a measure of complexity of the issue. The measure of complexity of the issue may be directly related to a number of products and services related to the issue. For example, an issue that is related to multiple products or services is determined to be more complex than an issue that concerns a single product or service. An issue may be considered as being related to a product or services if it impacts the usability of these products or service, for example, if the issue decreases usability of a product or service making it harder to use or impossible to use.

The recent interaction score module 230 analyzes information describing a user stored in the ticket store 240 to determine a recent interaction score for the user. According to an embodiment, the recent interaction score represents the number of user interactions with the helpdesk (e.g., the number of calls made by the user to the helpdesk) in a recent interval, for example, past 30 days. According to other embodiments, the recent interaction score may be determined as a weighted aggregate of the user interactions with the helpdesk in the recent time interval. Accordingly, different calls from a user may be weighted differently, for example, based on sentiment analysis of the call transcripts. As an example, a user call determined to have very negative sentiment may be weighted higher than a call determined to have less negative sentiment or positive sentiment. The recent interaction score may be determined by the recent interaction score module 230 every time a new call is received by the helpdesk from the user. The recent interaction score is used by the user interaction engine 150 to determine whether the user is dissatisfied based on the recent user interaction pattern. The system may control the interaction of the system with the user based on the recent interaction score in response to the new call received from the user.

If the recent interaction score of the user indicates that the user is dissatisfied when a new call is received from the user, the user interaction context module 220, collects information that is expected to be relevant during the discussion with the user during the new call. The information collected represents a context for the dissatisfaction of the user. The information is determined based on various factors, for example, whether the user repeatedly called for the same issue, a number of times the user has called the helpdesk recently, the types of issues for which the user called, and so on.

The information representing the context for the user dissatisfaction is presented via a user interface configured by the user interface module 210 and presented to an agent 110 via client device 115. The agent 110 of the helpdesk uses the information to guide an informed discussion with the user. For example, the agent may proactively describe the user's situation, thereby avoiding asking the user to repeat information that may already be stored in the ticket store 240.

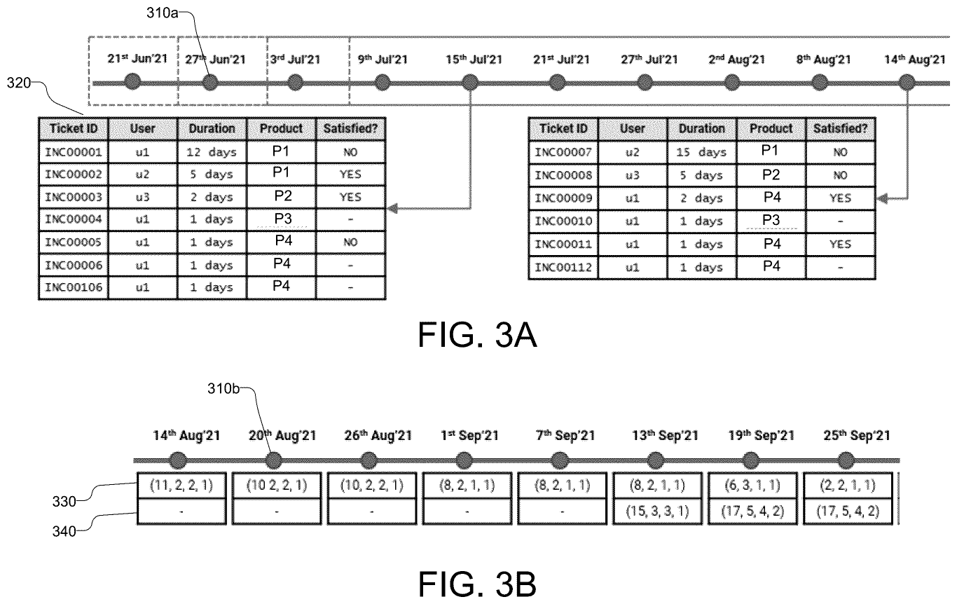

FIGS. 3A-B illustrates monitoring of user interactions with helpdesk according to an embodiment. FIG. 3A describes the various tickets that may be stored in the ticket store on a particular day. The timeline 310a shows the days and the table 320 shows the tickets that may have been processed that day, for example, a new ticket created that day or an existing ticket that was updated as a result of a new call to the helpdesk. Each ticket represents a record including fields such as the ticket identifier; a user identifier or username; a duration of the ticket indicating a length of time the ticket has been open in the system indicating the length of time that the issue of the user has not been resolved; a product or a service associated with the ticket; an indication of whether the user is satisfied or not based on the recent call with the helpdesk. A ticket may be associated with multiple calls and multiple tickets can be worked on by agents over a single call. A user interaction such as a call (or chat or an interaction using any other channel) is represented as an interaction object in the system and a user issue is represented as ticket. According to an embodiment a ticket is created for each user interaction with the system. According to other embodiments a ticket represents a particular issue faced by a user and multiple user interactions are associated with the same ticket i.e., the same issue. For example, when a user calls, the agent may ask the user to describe the issue (for example, by providing a ticket identifier) and if the issue exists in the system (i.e., the ticket was previously created in the system for that issue), the agent may add the information describing the new user interaction to an existing ticket.

The user interaction engine 150 analyzes the records stored in the ticket store to generate a summary periodically, for example, each day. The summary is based on the recent history of each user. The summary generated may include statistics based on time intervals of different lengths. For example, a 30 day frequency of calls 330 and a 90 day frequency of calls 340 is generated for each user. The call frequencies are used to generate the recent interaction score for each user.

Overall Process

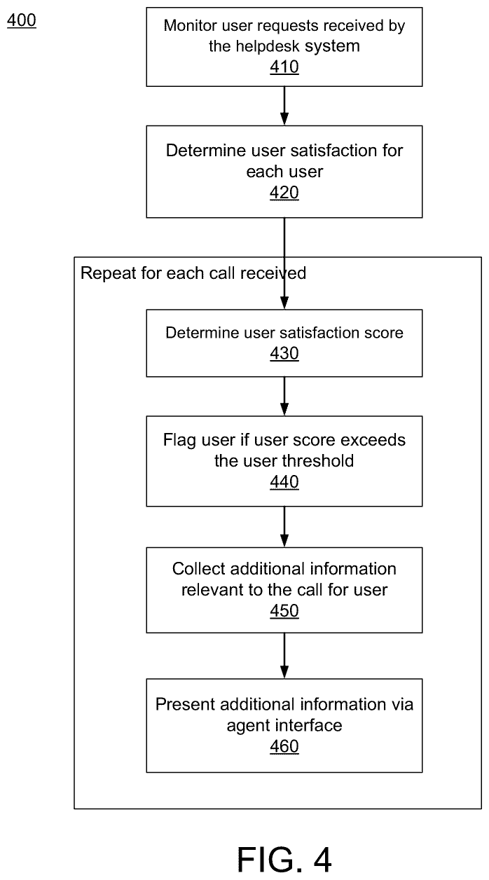

FIG. 4 is a flow chart illustrating the process 400 for collecting the information relevant for a user request to helpdesk according to an embodiment. Other embodiments can perform the steps of FIG. 4 in different orders. Other embodiments can include different and/or additional steps than the ones described herein.

The user interaction engine 150 monitors 410 user requests received by the helpdesk system. The user may contact the helpdesk system via any communication channel described herein. Each user request is associated with a record stored in the ticket store 240. Multiple user requests may be associated with the same ticket.

The user interaction engine 150 determines 420 a user satisfaction quota for each user. The user satisfaction quota is also referred to herein as a user threshold or a budget for the user. The user interaction engine 150 generates a recent interaction score for each user on a periodic basis, for example, after every user interaction such as a user call to the helpdesk. The user interaction engine 150 compares recent interaction score for the user with the user satisfaction quota of the user to determine whether the user should be flagged as being dissatisfied.

The steps 430, 440, 450, and 460 are repeated by the user interaction engine 150, for example, on a periodic basis, or whenever a new call is received by the helpdesk from the user. When a new call is received by the helpdesk from the user, the user interaction engine 150 determines 430 a recent interaction score as further described herein. If the user interaction engine 150 determines that the recent interaction score exceeds the user satisfaction quota for the user, the user interaction engine 150 flags 440 (or marks) the user as a dissatisfied user. The user interaction engine 150 further collects 450 additional information describing the context for the user satisfaction and generates a summary. The user interaction engine 150 configures a user interface describing the summary of the context for the user and sends 460 the additional information for presentation to the agent via the agent interface 135.

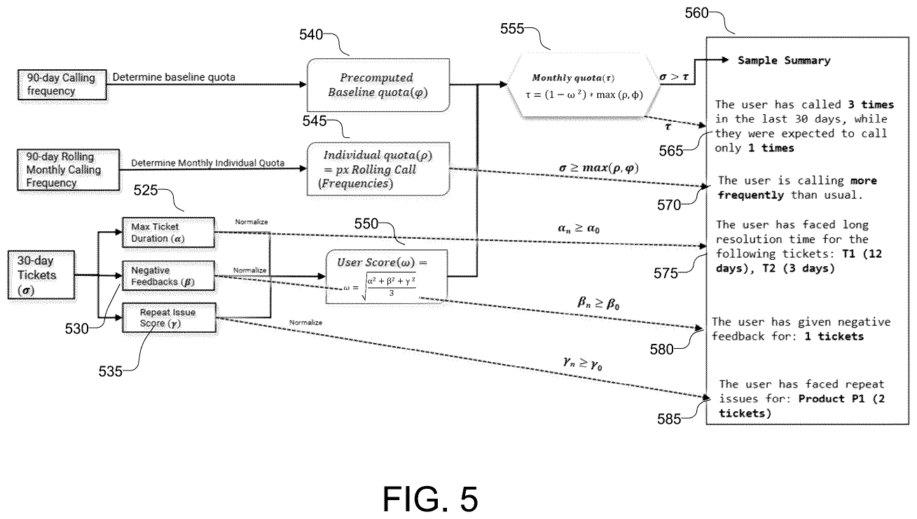

FIG. 5 illustrates the generation of a summary describing the context of the user interaction according to an embodiment. The system determines a satisfaction quota value that represents a threshold number of calls such that if a user more than the threshold number of calls to helpdesk in a time period (e.g., 90 days), the user is determined to be dissatisfied. Alternately, the satisfaction quota value represents a measure of a rate of calling the helpdesk such that if a user calls the helpdesk more than the threshold rate of calling according to the satisfaction quota, the user is determined to be dissatisfied. The satisfaction quota may be referred to as a satisfaction budget value.

The user interaction engine 150 determines 545 a user satisfaction quota p for an individual user based on data collected for the user during a recent time interval, for example, past 90 days. According to an embodiment, the user satisfaction quota p for the individual user is determined using the following equation where fᵢ represents an individual rolling call frequency, i.e., the frequency with which the user has been calling over a recent time interval, for example, past 30 days and p₉₉ represents the 99^{th} percentile value. The percentile value is determined over a set of calling frequency values that were determined over a time interval. For example, if the time interval is 90 days, the calling frequency over the previous 30 days is determined on a daily basis for each of the 90 days. Accordingly, a set Sᵢ of 90 values of calling frequency are determined over the 90 day interval. The user interaction engine 150 determines the user satisfaction quota p as a percentile of the set Sᵢ. The user satisfaction quota ρ may be computed as any N^{th} percentile where N is configurable.

ρ=P₉₉(fᵢ)

Different users may have different calling patterns. For example, a user's job may require the user to call the helpdesk more than another user. For example, a user whose job requires the user to use a complex product frequently may call the helpdesk more frequently compared to another user who does not use such products. As a result, the user satisfaction quota p for the individual user is determined based on past calling frequency of the user over a time interval instead of using a constant value across multiple users. Accordingly, based on individual user's calling patterns, a particular user may have user satisfaction quota p value that is different from the user satisfaction quota p value for another user. Accordingly, the system determines a user to be dissatisfied if the user is deviating significantly from the typical calling pattern of the user. Furthermore, the behavior of a user may change over time. For example, a user may be new to a product and may call more frequently for a time period. Over time the user may learn about the products and may reduce the calling frequency. Accordingly, the user satisfaction quota ρ value is recalculated periodically and updated so that the user satisfaction quota ρ value over a particular time interval may be different from the user satisfaction quota ρ value for the same user determined later during a different time interval.

The user interaction engine 150 determines 540 a baseline quota ϕ for users based on aggregate information describing multiple users, for example, all users of an organization. According to an embodiment, the baseline quota ϕ for a group of users determined using the following equation where f_{g} represents an individual rolling call frequency, i.e., the frequency with which the user has been calling over a recent time interval, for example, past 30 days and p₉₅ represents the 95^{th} percentile value. The percentile value is determined over a set of calling frequency values that were determined for the group of users over a time interval. For example, if the time interval is 90 days the calling frequency over the previous 30 days is determined on a daily basis for each user of the group for 90 days. Accordingly, a set Sₙ of n*90 values of calling frequency are determined over the 90 day interval if there are n users in the group of users. The user interaction engine 150 determines the user satisfaction quota ρ as a percentile of the set Sₙ. The baseline quota ϕ may be computed as any N^{th} percentile where N is configurable.

ϕ=P₉₅(f_{g})

The system may determine different values of baseline quota ϕ for different groups or categories of users. For example, if the helpdesk supports a set of different organizations, the user interaction engine 150 may determine a different baseline quota ϕ for each organization. When a user calls the helpdesk, the user interaction engine 150 determines the organization (or any corresponding category of users or group of users) and uses the baseline quota ϕ for that organization (or category or group of users) for analyzing the information for the user. According to an embodiment, the system determined categories of users based on various criteria such as their role in an organization, the types of products used by the user, and so on and determines a baseline quota ϕ for each category of users.

According to an embodiment, the baseline quota ϕ is determined based on a calling pattern of users of the group collected over a time interval, for example, a 90 day time interval. The baseline quota ϕ value for a group of users is updated on a periodic basis using the data of the most recent time interval. The use of baseline quota ϕ allows the user interaction engine 150 to handle a bootstrapping problem when there is not enough data for a user to analyze, for example, if the user has not made any calls to the help desk for a long time, for example, for past 4 months. In this situation, the user satisfaction quota ρ for the individual user may be zero. Having a low user satisfaction quota ρ for an individual user results in lots of false positives since the user may be frequently flagged as being dissatisfied user. In this situation, the system uses the baseline quota ϕ of the group of users associated with the user instead of the user satisfaction quota ρ for the individual user. According to an embodiment, the system uses max(ρ, ϕ), i.e., the maximum of the two values (1) user satisfaction quota ρ for the individual user and (2) baseline quota ϕ of the group of users associated with the user as the satisfaction quota for the user.

The user interaction engine 150 analyzes a recent time interval for a user to monitor various metrics. For example, the user interaction engine 150 may periodically (e.g., on a daily basis) analyze information for the past N number of days, where N may be 30, 60, 90, or another number. The user interaction engine 150 determines 525 a metric α based on the length of time taken to resolve issues of a user. The metric α may be determined using the maximum ticket duration, i.e., the longest time taken by an issue to get resolved for the user. The metric α is normalized to determine a normalized value ∝ₙ using the following equation that computes the ratio of the difference between ∝ and ∝ₘᵢₙ and the difference between ∝ₘₐₓ and ∝ₘᵢₙ, where ∝ₘᵢₙ is the minimum value of metric α determined for the user and ∝ₘₐₓ is the maximum value of metric α determined for the user.

$${∝}_{n} = \frac{∝ - {∝}_{min}}{{∝}_{max} - {∝}_{min}}$$

The metrics may be normalized using other techniques. According to an embodiment, the system removes one or more outliers before computing the minimum and maximum of these values as this makes the normalized values spread better in the range (0,1). Such normalization techniques may be applied to all the factors/features discussed herein.

The user interaction engine 150 determines 530 a metric β that represents a measure of user dissatisfaction based on explicit feedback provided by the user. The metric β may be determined using the number of instances of negative feedback given by the user during a recent time interval, for example, past 30 days. For example, the user interaction engine 150 identifies all instances of user feedback in which the rating provided by the user is below a threshold value or the comments provided by the user indicate negative sentiment based on natural language processing of the comments. The metric β is normalized to determine a normalized value βₙ, using the following equation that computes the ratio of the difference between β and βₘᵢₙ and the difference between βₘₐₓ and βₘᵢₙ where βₘᵢₙ is the minimum value of metric β determined for the user and βₘₐₓ is the maximum value of metric α determined for the user.

$${β}_{n} = \frac{β - {β}_{min}}{{β}_{max} - {β}_{min}}$$

The user interaction engine 150 determines 535 a metric γ representing a measure of user dissatisfaction based on the frequency with which the user repeatedly encountered the same issue within a time interval. Accordingly, the metric γ represents a repeat issue score, i.e., a measure of a rate at which the user has faced the same issue or issues of the same type repeatedly during the time interval. The metric γ is normalized to determine a normalized value γₙ using the following equation that computes the ratio of the difference between γ and γₘᵢₙ and the difference between γₘₐₓ and γₘᵢₙ, where γₘᵢₙ is the minimum value of metric γ determined for the user and γₘₐₓ is the maximum value of metric α determined for the user.

$${γ}_{n} = \frac{γ - {γ}_{min}}{{γ}_{max} - {γ}_{min}}$$

The user interaction engine 150 aggregates metric α, metric β, and metric γ to determine a user score ω. According to an embodiment, the user interaction engine 150 determines the user score ω based on a sum of squares of metric α, metric β, and metric γ. For example, the following equation may be used to calculate user score ω by determining the sum of squares of metrics α, β, and γ; dividing the sum by 3; and taking the square root of the result. Accordingly, user satisfaction score ω is determined 550 as the square root of the mean of the squares of the metrics α, β, and γ.

$$ω = \sqrt{\frac{{α}^{2} + {β}^{2} + {γ}^{2}}{3}}$$

According to some embodiments other factors are considered in determination of user satisfaction score, for example, a user sentiment score determined by performing user sentiment analysis of the call recordings associated with the user's historical tickets. Additional factors may be considered while determining repeat issue score, for example, natural language processing of transcripts, email/chat conversations and so on, is performed to detect if similar issue is referred across many tickets from the user's ticket history and the repeat issue score adjusted based on the analysis. For example, if the natural language processing determines occurrence of matching issue across multiple tickets, the repeat issue score is increased.

The user interaction engine 150 determines 555 an interval satisfaction quota τ (e.g., a monthly satisfaction quota or monthly satisfaction budget) for the user using the following equation.

τ=(1−ω²)*max(ρ,ϕ)

Accordingly, the interval satisfaction quota τ is determined based on the maximum of the user satisfaction quota ρ for the user and the baseline quota ϕ for the group of users associated with the user. The interval satisfaction quota τ is further determined based on the user satisfaction score ω. According to an embodiment, the interval satisfaction quota τ is further determined based on the value (1−ω²) where the maximum value of ω is 1. According to an embodiment, the interval satisfaction quota τ is determined as the product of a term based on the user satisfaction score ω, i.e., (1−ω²) and the maximum of the user satisfaction quota ρ for the user and the baseline quota ϕ for the group of users associated with the user.

The example summary 560 is generated by the user interaction engine 150 for a user. The context includes various components that are generated by the user interaction engine 150 including (1) Component 565 describes the number of times the user has called in a recent time interval, for example, in the last 30 days. (2) Component 570 that indicates that the user is calling at a rate that is higher than an expected rate of calls determined for the user. (3) Component 575 that is generated if the user has faced long resolution times for the users tickets, (4) Component 580 that is generated if the user has given negative feedback more than a threshold number of times. (5) Component 585 that is generated if the user has faced repeat issues. According to an embodiment, each component of the summary 560 is generated only when a corresponding metric value indicates that the component is significant for including in the summary.

The overall summary of the context is generated when the value of σ is greater than the value of τ indicating that the number of calls made by the user during the current time interval exceed a threshold determined by the quota for the user.

The component 565 is generated when the user call frequency in the recent time interval (e.g., past 30 days) is greater than an expected user call frequency determined based on the user satisfaction quota τ. The component 565 identifies the expected call frequency of the user and actual call frequency of the user in the recent time interval and mentions that the actual call frequency was greater than the expected call frequency.

The component 570 is generated when the value of σ representing the calling frequency of the user during a recent time interval (e.g., past 30 days) is greater than the max(ρ, ℠) i.e., the maximum of the two values (1) user satisfaction quota ρ for the individual user and (2) baseline quota ϕ of a group of users associated with the user, indicating high calling frequency for the user during the time interval. The component 570 states that the user is calling more frequently than usual. Component 565 provides an explanation of user dissatisfaction determined based on user satisfaction score (ω). Component 570 provides an explanation of user dissatisfaction determined based on calling frequency, for example, if the calling frequency exceeds a threshold value such as max(ρ, ϕ).

The component 575 is generated when the value of a n is greater than a threshold value of ∝, for example, ∝₀. Th component states that the user has faced long resolution times for certain tickets and may identify the tickets of the user for which the resolution time is greater than the threshold value ∝₀. The threshold value ∝c₀ may be configurable or determined based on analysis of stored tickets, for example, as an aggregate value (e.g., average) of resolution time of tickets of a group of users. According to an embodiment, different threshold values ∝c₀ may be determined as aggregates of resolution time of tickets of different types of tickets, for example, tickets associated with specific products or services.

The component 580 is generated when the value of βₙ is greater than a threshold value of β, for example, β₀. The component 580 states that the user has given negative feedback for one or more tickets. The component 580 may provide information describing the tickets for which the user has given negative feedback, for example, identifiers of the ticket and may list specific feedback provided by the user.

The component 585 is generated when the value of γₙ is greater than a threshold value of γ, for example, γ₀. The component 585 states that the user has faced repeat issues and may provide information describing the repeat issues, for example, a product or service for which the repeat issues were identified.

Computer Architecture

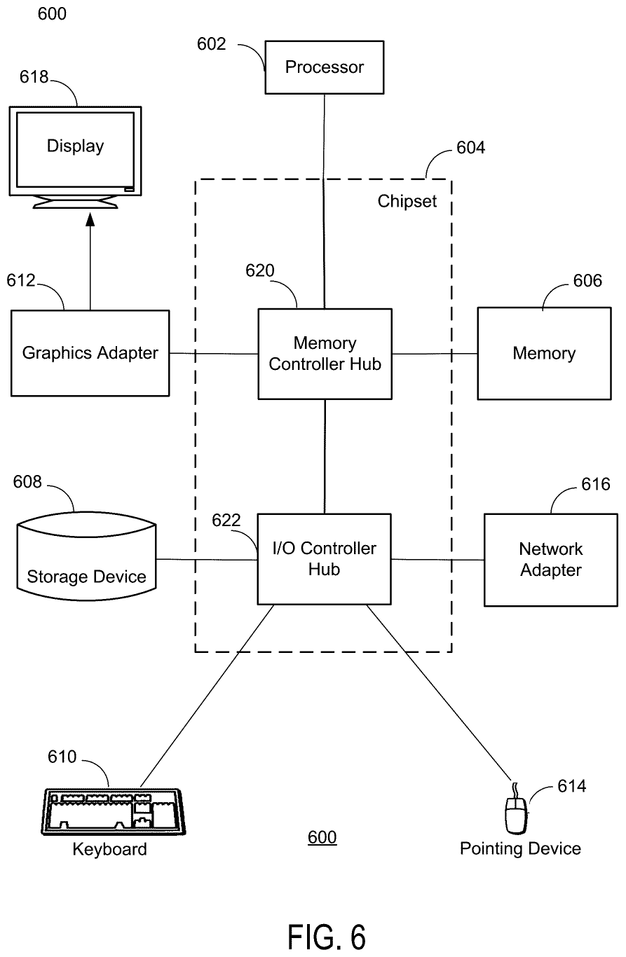

FIG. 6 is a high-level block diagram illustrating a functional view of a typical computer system for use as one of the entities illustrated in the environment 100 of FIG. 1 according to an embodiment. Illustrated are at least one processor 602 coupled to a chipset 604. Also coupled to the chipset 604 are a memory 606, a storage device 608, a keyboard 610, a graphics adapter 612, a pointing device 614, and a network adapter 616. A display 618 is coupled to the graphics adapter 612. In one embodiment, the functionality of the chipset 604 is provided by a memory controller hub 620 and an I/O controller hub 622. In another embodiment, the memory 606 is coupled directly to the processor 602 instead of the chipset 604.

The storage device 608 is a non-transitory computer-readable storage medium, such as a hard drive, compact disk read-only memory (CD-ROM), DVD, or a solid-state memory device. The memory 606 holds instructions and data used by the processor 602. The pointing device 614 may be a mouse, track ball, or other type of pointing device, and is used in combination with the keyboard 610 to input data into the computer system 600. The graphics adapter 612 displays images and other information on the display 618. The network adapter 616 couples the computer system 600 to a network.

As is known in the art, a computer 600 can have different and/or other components than those shown in FIG. 6. In addition, the computer 600 can lack certain illustrated components. For example, a computer system 600 acting as an online system 120 may lack a keyboard 610 and a pointing device 614. Moreover, the storage device 608 can be local and/or remote from the computer 600 (such as embodied within a storage area network (SAN)).

The computer 600 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 608, loaded into the memory 606, and executed by the processor 602.

The types of computer systems 600 used by the entities of FIG. 1 can vary depending upon the embodiment and the processing power used by the entity. For example, a client device 115 may be a mobile phone with limited processing power, a small display 618, and may lack a pointing device 614. The multi-tenant system 120, in contrast, may comprise multiple blade servers working together to provide the functionality described herein.

Additional Considerations

The particular naming of the components, capitalization of terms, the attributes, data structures, or any other programming or structural aspect is not mandatory or significant, and the mechanisms that implement the embodiments described may have different names, formats, or protocols. Further, the systems may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain embodiments described herein include process steps and instructions described in the form of an algorithm. It should be noted that the process steps and instructions of the embodiments could be embodied in software, firmware or hardware, and when embodied in software, could be downloaded to reside on and be operated from different platforms used by real time network operating systems.

The embodiments described also relate to apparatuses for performing the operations herein. An apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present embodiments are not described with reference to any particular programming language. It is appreciated that a variety of programming languages may be used to implement the teachings of the embodiments as described herein.

The embodiments are well suited for a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the embodiments is intended to be illustrative, but not limiting.

What is claimed is:

1. A computer-implemented method for managing user interactions with a helpdesk, the method comprising:
monitoring, by an online system, user requests received by a helpdesk from users, the helpdesk associated with an online system and one or more agents;
determining a user satisfaction quota for a user based on an aggregate frequency with which the user called the helpdesk within a previous time interval;
receiving, by the helpdesk, a call from the user, wherein the call is answered by an agent of the helpdesk;
determining a recent interaction score based on factors comprising a frequency with which the user called the helpdesk in a time interval;
comparing the recent interaction score of the user with the user satisfaction quota for the user;
responsive to determining based on the comparison, that the recent interaction score exceeds the user satisfaction quota for the user, marking the user as a dissatisfied user;
responsive to marking the user as a dissatisfied user, generating a summary of a context identifying factors likely to contribute to dissatisfaction of the user; and
sending the summary of the context for presentation to the agent of the helpdesk.

2. The computer-implemented method of claim 1, wherein determining the recent interaction score comprises determining a set of scores based on factors likely to contribute to dissatisfaction of the user, the method further comprising:
determining an aggregate value based on the set of scores, each score based on a factor likely to contribute to dissatisfaction of the user; and
determining the user satisfaction quota based on the aggregate value.

3. The computer-implemented method of claim 2, wherein the set of scores includes a repeat issue score determined based on a number of times the user called for a same issue in the time interval.

4. The computer-implemented method of claim 2, wherein the set of scores includes a negative feedback score determined based on a number of times the user provided negative feedback in the time interval.

5. The computer-implemented method of claim 2, wherein the set of scores includes a score representing a measure of user dissatisfaction based on a frequency with which the user repeatedly encountered an issue within a time interval.

6. The computer-implemented method of claim 2, wherein the set of scores includes a score representing a measure of user dissatisfaction based on a frequency with which the user repeatedly encountered an issue within a time interval.

7. The computer-implemented method of claim 1, wherein the user satisfaction quota is determined based on a percentile value obtained from a set of calling frequencies determined over a time interval for the user, wherein each calling frequency is determined at a point in time during the time interval.

8. The computer-implemented method of claim 1, further comprising, determining a baseline satisfaction quota based on calling frequency of a set of users, wherein the baseline satisfaction quota is determined based on a percentile value obtained from a set of calling frequencies determined over a time interval for users from the set of users.

9. A non-transitory computer readable storage medium storing instructions that when executed by a computer processor, cause the computer processor to perform steps comprising:
monitoring user requests received by a helpdesk from users, the helpdesk associated with an online system and one or more agents;
determining a user satisfaction quota for a user based on an aggregate frequency with which the user called the helpdesk within a previous time interval;
receiving, by the helpdesk, a call from the user, wherein the call is answered by an agent of the helpdesk;
determining a recent interaction score based on factors comprising a frequency with which the user called the helpdesk in a time interval;
comparing the recent interaction score of the user with the user satisfaction quota for the user;
responsive to determining based on the comparison, that the recent interaction score exceeds the user satisfaction quota for the user, marking the user as a dissatisfied user;
responsive to marking the user as a dissatisfied user, generating a summary of a context identifying factors likely to contribute to dissatisfaction of the user; and
sending the summary of the context for presentation the agent of the helpdesk.

10. The non-transitory computer readable storage medium of claim 9, wherein determining the recent interaction score comprises determining a set of scores based on factors likely to contribute to dissatisfaction of the user, the instructions further causing the computer processor to perform steps comprising:
determining an aggregate value based on the set of scores, each score based on a factor likely to contribute to dissatisfaction of the user; and
determining the user satisfaction quota based on the aggregate value.

11. The non-transitory computer readable storage medium of claim 10, wherein the set of scores includes a repeat issue score determined based on a number of times the user called for a same issue in the time interval.

12. The non-transitory computer readable storage medium of claim 10, wherein the set of scores includes a negative feedback score determined based on a number of times the user provided negative feedback in the time interval.

13. The non-transitory computer readable storage medium of claim 10, wherein the set of scores includes a score representing a measure of user dissatisfaction based on a frequency with which the user repeatedly encountered an issue within a time interval.

14. The non-transitory computer readable storage medium of claim 10, wherein the set of scores includes a score representing a measure of user dissatisfaction based on a frequency with which the user repeatedly encountered an issue within a time interval.

15. The non-transitory computer readable storage medium of claim 9, wherein the user satisfaction quota is determined based on a percentile value obtained from a set of calling frequencies determined over a time interval for the user, wherein each calling frequency is determined at a point in time during the time interval.

16. The non-transitory computer readable storage medium of claim 9, further comprising, determining a baseline satisfaction quota based on calling frequency of a set of users, wherein the baseline satisfaction quota is determined based on a percentile value obtained from a set of calling frequencies determined over a time interval for users from the set of users.

17. A computer system comprising:
a computer processor; and
a non-transitory computer readable storage medium storing instructions that when executed by the computer processor cause the computer processor to perform steps comprising:
monitoring user requests received by a helpdesk from users, the helpdesk associated with an online system and one or more agents;
determining a user satisfaction quota for a user based on an aggregate frequency with which the user called the helpdesk within a previous time interval;
receiving, by the helpdesk, a call from the user, wherein the call is answered by an agent of the helpdesk;
determining a recent interaction score based on factors comprising a frequency with which the user called the helpdesk in a time interval;
comparing the recent interaction score of the user with the user satisfaction quota for the user;
responsive to determining based on the comparison, that the recent interaction score exceeds the user satisfaction quota for the user, marking the user as a dissatisfied user;
responsive to marking the user as a dissatisfied user, generating a summary of a context identifying factors likely to contribute to dissatisfaction of the user; and
sending the summary of the context for presentation the agent of the helpdesk.

18. The computer system of claim 17, wherein determining the recent interaction score comprises determining a set of scores based on factors likely to contribute to dissatisfaction of the user, the instructions further causing the computer processor to perform steps comprising:
determining an aggregate value based on the set of scores, each score based on a factor likely to contribute to dissatisfaction of the user; and
determining the user satisfaction quota based on the aggregate value.

19. The computer system of claim 17, wherein the user satisfaction quota is determined based on a percentile value obtained from a set of calling frequencies determined over a time interval for the user, wherein each calling frequency is determined at a point in time during the time interval.

20. The computer system of claim 17, further comprising, determining a baseline satisfaction quota based on calling frequency of a set of users, wherein the baseline satisfaction quota is determined based on a percentile value obtained from a set of calling frequencies determined over a time interval for users from the set of users.
